(19) United States
(12) Patent Application Publication
(10) Pub. No.: US 2020/0081649 A1
(43) Pub. Date: Mar. 12, 2020

(54) DATA STORAGE DEVICE, OPERATION METHOD THEREOF AND STORAGE SYSTEM INCLUDING THE SAME

(71) Applicant: SK hynix Inc., Gyeonggi-do (KR)

(72) Inventors: Hoe Seung JUNG, Seoul (KR); Dae Seok SHIN, Gyeonggi-do (KR); Joo Young LEE, Seoul (KR); Dong Yeob CHUN, Seoul (KR)

(21) Appl. No.: 16/396,084

(22) Filed: Apr. 26, 2019

(30) Foreign Application Priority Data
Sep. 7, 2018 (KR) 10-2018-0107052

(51) Int. Cl. G06F 3/06; G06F 12/0868

(52) U.S. Cl. CPC G06F 3/0656; G06F 12/0868; G06F 3/0641; G06F 3/0652; G06F 3/0611; G06F 3/0679

(57) ABSTRACT

A data storage device includes: a storage configured to generate a program completion signal when a data chunk is completely programmed; a buffer memory having a plurality of buffer regions configured to cache a plurality of data chunks, respectively; and a controller configured to receive a data chunk from a host device while a previously cached data chunk in the buffer memory is programmed to the storage; cache the received data chunk into the buffer memory; delete the programmed data chunk from the buffer memory in response to the program completion signal; receive a new data chunk from the host device; and cache the received new data chunk in an empty buffer region of the buffer memory.

### CROSS-REFERENCES TO RELATED APPLICATION

The present application claims priority under 35 U.S.C. § 119(a) to Korean application number 10-2018-0107052, filed on Sep. 7, 2018, which is incorporated herein by reference in its entirety.

### BACKGROUND

### 1. Technical Field

Various embodiments generally relate to a semiconductor integrated device, and more particularly, to a data storage device, an operation method thereof and a storage system including the same.

### 2. Related Art

A storage device is coupled to a host device and performs a data input/output operation according to a request of the host device. The storage device may use a variety of storage media to store data.

Since a storage medium using the flash memory supports a large capacity, has a nonvolatile characteristic, low unit price, small power consumption, and provides a high data processing speed, the demand for the storage medium using the flash memory is continuously increasing.

The flash memory may be configured as a solid state drive (SSD) memory to replace a hard disk, or an embedded memory or mobile memory which can be used as a built-in memory. The flash memory is applied to various electronic devices.

With the development of electronic devices, storage media are required to have a higher capacity, higher integration density, smaller size, higher performance, and higher speed. In particular, the performance of a storage medium used for processing large data may be determined by its data processing speed.

### SUMMARY

In an embodiment, a data storage device may include: a storage configured to generate a program completion signal when a data chunk is completely programmed; a buffer memory having a plurality of buffer regions configured to cache a plurality of data chunks, respectively; and a controller configured to receive a data chunk from a host device while a previously cached data chunk in the buffer memory is programmed to the storage; cache the received data chunk into the buffer memory; delete the programmed data chunk from the buffer memory in response to the program completion signal; receive a new data chunk from the host device; and cache the received new data chunk in an empty buffer region of the buffer memory.

In an embodiment, a data storage device may include: a storage; a buffer memory divided into a plurality of buffer regions; and a controller configured to transfer a data chunk cached in the buffer memory to the storage; cache a new data chunk into an empty buffer region of the buffer memory while the transferred data chunk is programmed; release a buffer region in which the transferred data chunk is cached, in response to a program completion signal provided from the storage at a point in time when the transferred data chunk is completely programmed; and assign the released buffer region as the empty buffer region.

In an embodiment, there is provided an operation method of a data storage which includes a storage, a buffer memory and a controller configured to control data exchange with the storage, the operation method comprising the steps of: caching, by the controller, a data chunk transferred from a host device into the buffer memory; transferring, by the controller, the data chunk cached in the buffer memory to the storage to program the data chunk; receiving, by the controller, a new data chunk from the host device and caching the new data chunk into the buffer memory. while the transferred data chunk is programmed; generating, by the storage, a program completion signal when the transferred data chunk is completely programmed, and providing the generated program completion signal to the controller; and deleting, by the controller, the programed data chunk from the buffer memory; and assigning, by the controller, a buffer region, where the programmed data chunk is deleted, as an empty buffer region of the buffer memory.

In an embodiment, a storage system may include: a host device; and a data storage device comprising: a storage configured to generate a program completion signal when a data chunk is completely programmed; a buffer memory having a plurality of buffer regions configured to cache a plurality of data chunks, respectively; and a controller configured to control data exchange with the storage, wherein the controller: receives a new data chunk from the host device while the data chunk cached in the buffer memory are programmed to the storage; caches the received data chunk into the buffer memory; deletes the programmed data chunk from the buffer memory in response to the program completion signal; receives another new data chunk from the host device; and caches the another new data chunk in an empty buffer region of the buffer memory.

In an embodiment, a memory system may include: a storage configured to generate a program completion signal when a data chunk is programmed; a buffer memory having a plurality of buffer regions configured to cache a plurality of data chunks, respectively; and a controller configured to receive a data chunk from a host device to cache the received data chunk into the buffer memory while a previously cached data chunk in the buffer memory is programmed to the storage; delete the programmed data chunk cached in a buffer region of the buffer memory in response to the program completion signal; and assign the buffer region, where the programmed data chunk is deleted, as an empty buffer region of the buffer memory.

### BRIEF DESCRIPTION OF THE DRAWINGS

FIG. 1 is a configuration diagram illustrating a data storage device in accordance with an embodiment.

FIG. 2 is a configuration diagram illustrating a controller in accordance with the present embodiment.

FIG. 3 is a flowchart illustrating an operation method for a data storage device in accordance with an embodiment.

FIG. 4 is a timing diagram for describing a program method in accordance with an embodiment.

FIGS. 5A to 5D are diagrams for describing a status change of a buffer memory during a program operation in accordance with the present embodiment.

FIG. 6 is a diagram for describing a program completion reporting method in accordance with an embodiment.

FIG. 7 is a diagram for describing a program completion reporting method in accordance with an embodiment.

FIG. 8 is a diagram illustrating a data storage system in accordance with an embodiment.

FIG. 9 and FIG. 10 are diagrams illustrating a data processing system in accordance with an embodiment.

FIG. 11 is a diagram illustrating a network system including a data storage device in accordance with an embodiment.

FIG. 12 is a block diagram illustrating a nonvolatile memory device included in a data storage device in accordance with an embodiment.

### DETAILED DESCRIPTION

Hereinafter, a data storage device, an operation method thereof and a storage system including the same according to the present disclosure will be described below with reference to the accompanying drawings through exemplary embodiments.

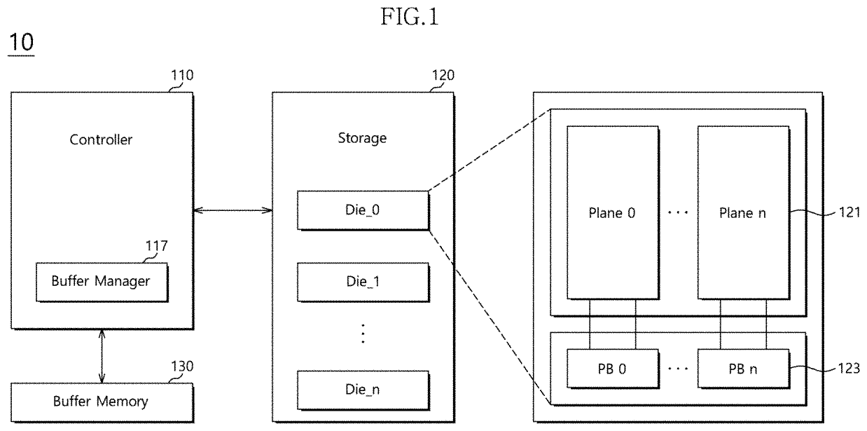

FIG. 1 is a configuration diagram illustrating a data storage device 10 in accordance with an embodiment.

Referring to FIG. 1, the data storage device 10 in accordance with the present embodiment may include a controller 110, a storage 120 and a buffer memory 130.

The controller 110 may control the storage 120 in response to a request of a host device. For example, the controller 110 may control the storage 120 to program data according to a program (write) request of the host device. Also, the controller 110 may provide data stored in the storage 120 to the host device in response to a read request of the host device.

The storage 120 may write data or output data written therein according to control of the controller 110. The storage 120 may be configured as a volatile or nonvolatile memory device. In an embodiment, the storage 120 may be implemented with a memory device selected from various nonvolatile memory devices such as an EEPROM (Electrically Erasable and Programmable ROM), NAND flash memory, NOR flash memory, PRAM (Phase-Change RAM), ReRAM (Resistive RAM), FRAM (Ferroelectric RAM) and STT-MRAM (Spin Torque Transfer Magnetic RAM). The storage 120 may include a plurality of dies Die 0 to Die n, a plurality of chips or a plurality of packages. Furthermore, the storage 120 may include single-level cells each configured to store one-bit data therein or multi-level cells each configured to store multi-bit data therein.

In an embodiment, the storage 120 may include a memory cell array 121 and a page buffer 123.

The memory cell array 121 may include a plurality of memory cells coupled between a plurality of word lines and a plurality of bit lines. The memory cell array 121 may be divided into a plurality of planes Plane 0 to Plane n.

The page buffer 123 may include a plurality of page buffer circuits PB 0 to PB n. In an embodiment, the page buffer 123 may be installed for each of the planes Plane 0 to Plane n.

The page buffer 123 may include read/write circuits corresponding to the respective bit lines of the memory cell array 121. During a write operation, data provided from the host device may be cached into the buffer memory 130 through the controller 110, and then written to the memory cell array 121 through the page buffer 123. During a read operation, data read from the memory cell array 121 may be loaded to the page buffer 123, and then provided to the host device through the controller 110.

The buffer memory 130 may serve as a space for caching data when the data storage device 10 performs a series of operations of writing or reading data while interworking with the host device. FIG. 1 illustrates that the buffer memory 130 is positioned outside the controller 110, but the buffer memory 130 may be positioned inside the controller 110.

The buffer memory 130 may be controlled by a buffer manager 117.

The buffer manager 117 may divide the buffer memory 130 into a plurality of buffer regions (slots), and assign each of the buffer regions to cache data or release the assigned buffer region. When a buffer region is assigned, it may indicate that data are cached in the buffer region or data cached in the buffer region are valid. When a buffer region is released, it may indicate that data are not cached in the buffer region or data cached in the buffer region are invalidated.

In an embodiment, as a program completion signal is transferred from the storage 120, the buffer manager 117 may release a buffer region in which completely programmed unit data is cached. Then, the buffer manager 117 may cache new program data provided from the host device in the released buffer region.

The unit data may indicate a data group which is programmed to or read from the memory cell array 121 at a time.

In an embodiment, the controller 110 may perform a write operation in a normal program mode or cache program mode.

In the normal program mode, second data to be written next may be stored in the buffer memory 130 after first data is completely written to the memory cell array 121 of the storage 120.

In the cache program mode, second data to be written next may be stored in the buffer memory 130 while first data is being written to the memory cell array 121 of the storage 120.

The buffer memory 130 may have a limited capacity. Particularly, in the case of the data storage device 10 installed in a mobile electronic device, the capacity of the buffer memory 130 may be further limited.

Therefore, in the cache program mode, the buffer memory 130 may be released to cache new data, as soon as programming is normally completed, which makes it possible to maximize the performance of the data storage device 10.

The controller 110, in accordance with the present embodiment, may be configured to cache data, or data chunk, to be programmed next into an empty slot of the buffer memory 130, while data previously cached in the buffer memory 130 are being programmed in the storage 120. Furthermore, the controller 110 may receive the program completion signal from the storage 120 at the point of time when previously cached data, or data chunk, are completely programmed. In response to the program completion signal, the controller 110 may release the buffer slot in which previously cached data are stored, and assign the released buffer slot for new data, or new data chunk, to be programmed.

Furthermore, the data storage device 10, in accordance with the present embodiment, may receive new unit data, or new data chunk, from the host device and stores the received data in the buffer memory 130 while unit data, or data chunk, previously provided from the buffer memory 130 is being programmed to the storage 120.

The storage 120 may be configured to generate the program completion signal on or shortly after the unit data is completely programmed.

The buffer memory 130 may be configured to cache a plurality of unit data into the respective slots.

The controller 110 may program data, or data chunk, previously cached in the buffer memory 130 to the storage 120, delete the previously cached data, or data chunk, completely programmed from the buffer memory 130 in response to the program completion signal provided from the storage 120, receive new unit data from the host device, and store the received data in an empty slot of the buffer memory 130.

The operation receiving new unit data to store the received new data in the buffer memory 130 may be performed in parallel with the operation of programing the previously cached unit data of the buffer memory 130 to the storage 120. That is, the operation of caching the new unit data, or the new data chunk, and the operation of programming the previously cached unit data to a memory cell may be performed at the same time.

The storage 120 may include a plurality of dies, and the plurality of dies may receive unit data from the buffer memory 130 at the same time, and program the received unit data. That is, the controller 110 may control the program operation through a die interleaving scheme.

In an embodiment, the storage 120 may transfer the program completion signal in response to a status read command READ STATUS of the controller 110. In an embodiment, the storage 120 may generate and transfer the program completion signal according to an internal ready/busy signal Internal RB/, an external ready/busy signal External RB/ or a combination thereof.

The method in which the storage 120 generates and transfers the program completion signal will be described below in detail.

Generation and transfer of the program completion signal during a cache program operation according to a conventional art is as follows. When a program operation for the current page is being performed after a program operation for the previous page is completed, the program completion signal for the program-completed previous page is not immediately transferred to a controller even after the completion of the program operation for the previous page. The program completion signal for the previous page is transferred to the controller after the previous page is completely programed and the current page is programmed by ⅔.

That is, the point in time when the program completion signal for a program-target page is transferred may be set to a later point in time than the point in time when the program operation for the program-target page is completed. Therefore, the point in time when the data programmed to the program-target page are deleted from the buffer memory may be inevitably delayed. The delay may cause performance degradation of the controller and the host device.

In the present embodiment, however, the storage 120 transfers the program completion signal for a program-target page to the controller 110 as soon as the program-target page is completely programmed. Therefore, the buffer region in which the completely programmed data are cached may be immediately released to cache new data.

Furthermore, the controller 110 may transfer new data from the host device to the buffer memory 130 in parallel to the operation of performing a program operation on the storage 120. Therefore, it is possible to remove a time delay caused by an overhead of the host device, for example, the time required for transferring data from the host device to the buffer memory 130 or the time required for the host device to drive the storage 120 for program.

FIG. 2 is a configuration diagram illustrating the controller 130 in accordance with the present embodiment.

Referring to FIG. 2, the controller 110 in accordance with the present embodiment may include a CPU 111, a host interface 113, a ROM 1151, a RAM 1153, the buffer manager 117 and a memory interface 119.

The CPU 111 may be configured to transfer various pieces of control information to the host interface 113, the RAM 1153, the buffer manager 117 and the memory interface 119, the various pieces of control information being required for reading or writing data from or to the storage 120. In an embodiment, the CPU 111 may operate according to firmware provided for various operations of the data storage device 10. In an embodiment, the CPU 111 may perform a function of a flash translation layer (FTL) for performing garbage collection, address mapping or wear leveling to manage the storage 120 or a function of detecting and correcting an error of data read from the storage 120.

The host interface 113 may provide a communication channel for receiving a command and clock signal from the host device and controlling data input/output, according to control of the CPU 111. In particular, the host interface 113 may provide a physical connection between the host device and the data storage device 10. Furthermore, the host interface 113 may provide an interface with the data storage device 10 according to the bus format of the host device. The bus format of the host device may include one or more standard interface protocols such as secure digital, Universal Serial Bus (USB), Multi-Media Card (MMC), Embedded MMC (eMMC), Personal Computer Memory Card International Association (PCMCIA), Parallel Advanced Technology Attachment (PATA), Serial Advanced Technology Attachment (SATA), Small Computer System Interface (SCSI), Serial Attached SCSI (SAS), Peripheral Component Interconnection (PCI), PCI Express (PCI-e or PCIe) and Universal Flash Storage (UFS).

The ROM 1151 may store program codes required for an operation of the controller 110, for example, firmware or software. Furthermore, the ROM 1151 may store code data used by the program codes.

The RAM 1153 may store data required for an operation of the controller 110 or data generated by the controller 110.

The CPU 111 may control a booting operation of the data storage device 10 by loading a boot code stored in the storage 120 or the ROM 1151 into the RAM 1153 during the booting operation.

The buffer manager 117 may be configured to manage the use statuses of the respective buffer regions of the buffer memory 130. In an embodiment, the buffer manager 117 may divide the buffer memory 130 into the plurality of buffer regions (or slots), and assign each of the buffer regions to cache data or release the assigned buffer region.

In an embodiment, the buffer manager 117 may release the buffer region in which completely programmed unit data (e.g., data chunk) is cached, in response to the program completion signal transferred from the storage 120. The released buffer region may be assigned to store new unit data (e.g., data chunk) provided from the host device.

The memory interface 119 may provide a communication channel for transmitting/receiving signals between the controller 110 and the storage 120. The memory interface 119 may write data to the storage 120 according to control of the CPU, the data being cached in the buffer memory 130. Furthermore, the memory interface 119 may transfer data read from the storage 120 to the buffer memory 130 to cache the data.

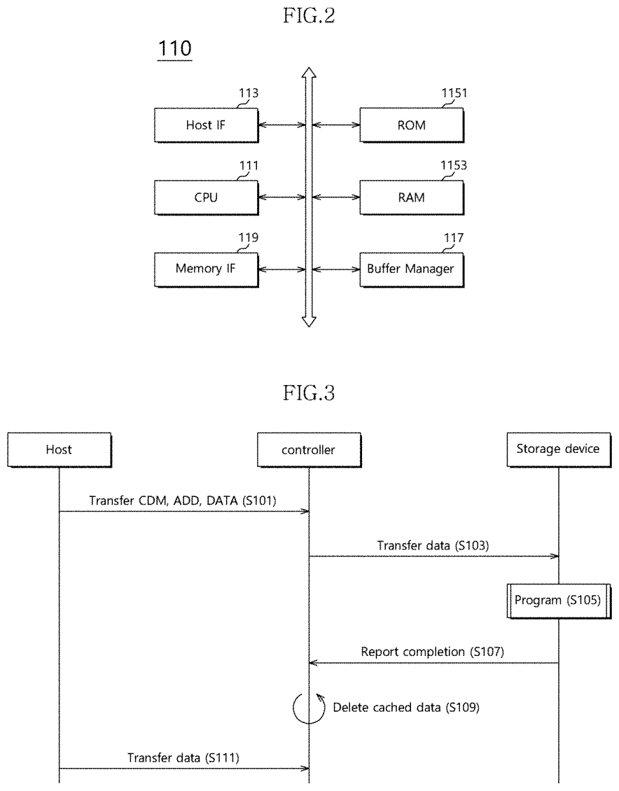

FIG. 3 is a flowchart for describing an operation method for the data storage device 10 in accordance with an embodiment.

For a cache program operation, a command CMD (for example, 80h), an address ADD, and data DATA may be transferred to the controller 110 from the host device at step S101. The transferred data may be cached into the buffer memory 130.

The controller 110 may transfer the data cached in the buffer memory 130 to the storage 120 or actually the page buffer 123 of the storage 120 at step S103.

The storage 120 may perform a program operation to store the data of the page buffer 123 in a memory cell corresponding to the address ADD according to control of an internal controller (not illustrated) at step S105. The storage 120 may transfer a program completion signal to the controller 110 as soon as the program operation S105 is completed, at step S107.

In response to the program completion signal, the controller 110 may release the buffer region of the buffer memory 130 caching the programmed data and may delete the completely programmed data from the buffer region at step S109. New unit data provided from the host device may be stored in the empty or released buffer region of the buffer memory 130, from which the program-completed data has been deleted, at step S111.

The program operation illustrated in FIG. 3 may be performed in an interleaving manner among a plurality of dies.

The program operation illustrated in FIG. 3 may be independently performed on each unit data.

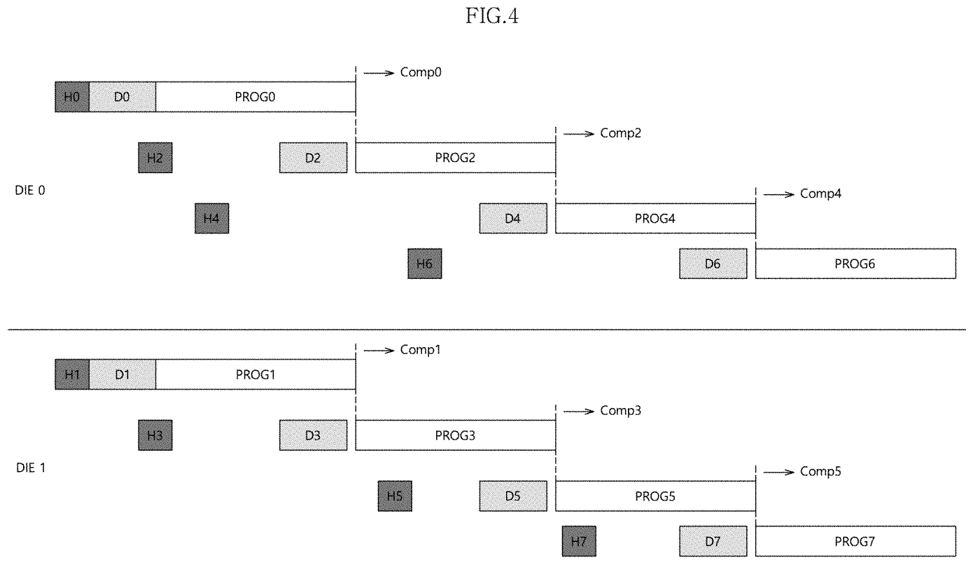

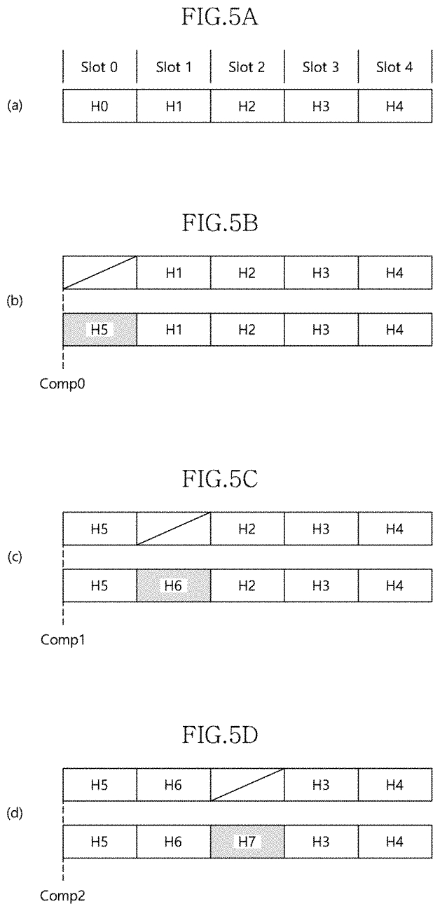

FIG. 4 is a timing diagram for describing a program method in accordance with an embodiment, and FIGS. 5A to 5D are diagrams for describing status changes of the buffer memory 130 during the program operation in accordance with the present embodiment.

FIGS. 4 and 5A to 5D illustrate that program operations are performed in an interleaving manner between two dies DIE0 and DIE1, and the buffer memory 130 caches data into five slots (or buffer regions).

Referring to FIGS. 4 and 5A, the controller 130 may store zeroth to fourth data H0 to H4, which are provided from the host device, in slots Slot0 to Slot4 of the buffer memory 130, respectively.

Since program operations are performed in an interleaving manner between two dies, the zeroth data, or data chunk H0 and the first data, or first data chunk, H1 may be simultaneously programmed to the zeroth die DIE0 and the first die DIE1, respectively, and the second data, or second data chunk, H2 and the third data, or third data chunk, H3 may be simultaneously programmed to the zeroth die DIE0 and the first die DIE1, respectively. Furthermore, the fourth data, or fourth data chunk, H4 and fifth data, or fifth data chunk, H5 may be simultaneously programmed to the zeroth die DIE0 and the first die DIE1, respectively, and sixth data, or sixth data chunk, H6 and seventh data, or seventh data chunk, H7 may be simultaneously programmed to the zeroth die DIE0 and the first die DIE1, respectively. In this way, the program operations may be performed in an interleaving manner.

According to the order in which the data are programmed, the description will be made as follows. The first data H1 of the first slot or buffer region Slot1 within the buffer memory 130 may be stored (D1) in the page buffer of the first die DIE1 almost at the same time when the zeroth data H0 of the zeroth slot or buffer region Slot0 within the buffer memory 130 is stored (D0) in the page buffer of the zeroth die DIE0.

Furthermore, the first data D1 of the page buffer within the first die DIE1 may be programmed (PROG1) to the memory cell array at the same time when the zeroth data D0 of the page buffer within the zeroth die DIE0 is programmed (PROG0) to the memory cell array.

The storage 120 may generate a program completion signal Comp0 as soon as the program PROG0 of the zeroth data D0 is completed, and transfer the program completion signal Comp0 to the controller 110.

As illustrated in FIG. 5B, the controller 110 may release the slot or buffer region in which the zeroth data H0 are cached, in response to the program completion signal Comp0 for the zeroth data H0, and assign the released buffer region to store the fifth data H5 newly transferred from the host device. The fifth data H5 may be scheduled to be programmed to the first die DIE1 at the same time when the fourth data H4 is programmed to the zeroth die DIE0.

The storage 120 may generate a program completion signal Comp1 as soon as the program PROG1 of the first data D1 is completed, and transfer the program completion signal Comp1 to the controller 110.

As illustrated in FIG. 5C, the controller 110 may release the slot or buffer region in which the first data H1 is cached, in response to the program completion signal Comp1 for the first data H1, and assign the released slot or buffer region to store the sixth data H6 newly transferred from the host device. The sixth data H6 may be scheduled to be programmed to the zeroth die DIE0 at the same time when the seventh data H7 is programmed to the first die DIE1.

Similarly, as illustrated in FIG. 5D, the cached second data H2 may be deleted from the buffer memory 130 in response to a program completion signal Comp2 which is generated as soon as the second data D2 is completely programmed (PROG2) to the zeroth die DIE0, and the released slot or buffer region may be assigned to cache the seventh data H7 as new unit data. The third data D3 may be programmed (PROG3) to the first die DIE1 at the same time when the second data D2 is programmed (PROG2), and the cached third data H3 may be deleted from the buffer memory 130 in response to a program completion signal Comp3 which is generated as soon as the third data D3 are completely programmed.

In the cache program mode, a time delay (host overhead) may occur. For example, time may be required for the host device to transfer data to the buffer memory 130 through the controller 110, or time may be required for driving the storage 120 to program data of the buffer memory 130 to the storage 120. Furthermore, a time delay (controller overhead) may occur when the controller 110 assigns a slot or a buffer region to internally cache unit data and generates buffer assignment information. Such overheads may serve as a factor to reduce the advantages of the cache program mode.

In the present embodiment, while the previous unit data is programmed into the memory cell array, new unit data from the host device may be cached in parallel, which makes it possible to remove overheads of the host device and the controller. Therefore, while the write speed is improved, the entire performance of the system can be maximized.

In particular, a host overhead is a factor which is impossible for the controller 110 to control. In the present embodiment, since an operation accompanied by a host overhead is performed while the previous unit data is programmed, the host overhead can be removed.

Host and controller overheads which occur while unit data is cached may serve as a factor to break interleaving between dies. In the present embodiment, however, such overheads can be removed to maximize the interleaving performance.

As described above, the storage 120 may generate a program completion signal as soon as the current unit data is programmed to the memory cell array, in order to report the generated program completion signal to the controller 110.

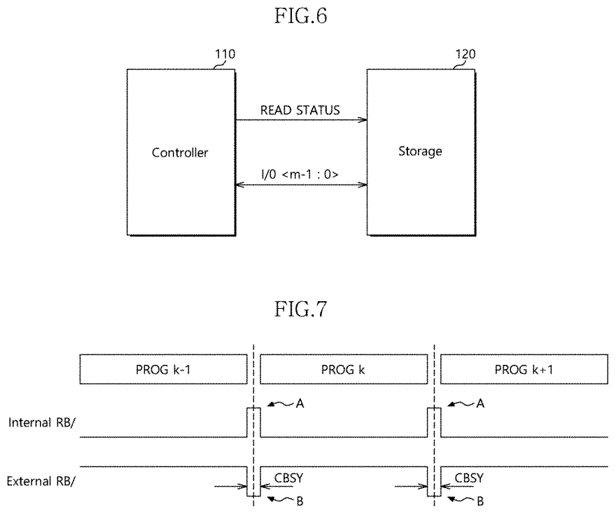

FIG. 6 is a diagram for describing a program completion reporting method in accordance with an embodiment.

As illustrated in FIG. 6, the storage 120 may transfer a program completion signal in response to a status read command READ STATUS of the controller 110.

The controller 110 may use the status read command READ STATUS to monitor the status of the storage 120. When the controller 110 transfers the status read command READ STATUS to the storage 120, the storage 120 may output status information stored in an internal status register.

The status register may provide the status information to the controller 110 through plural-bit (m-bit) input/output ports, for example, 8-bit input/output ports.

In the present embodiment, the storage 120 may be configured to output the program completion signal using any one of the output ports of the status register, for example, any one bit of the plural-bit status information.

That is, the storage 120 may change the value of a specific bit of the status register to a preset level, as soon as data of the page buffer is programmed to the memory cell array. The controller 110 may issue the status read command READ STATUS to the storage 120, and check whether the program is completed, based on the level of the specific bit of the status information outputted in response to the status read command READ STATUS. In an embodiment, the status read command READ STATUS may be transferred based on a preset time point, for example, a point of time when a page program confirm command 10h is issued to input the data of the page buffer to the memory cell array. However, the present embodiment is not limited thereto.

FIG. 7 is a diagram for describing a program completion reporting method in accordance with an embodiment.

As illustrated in FIG. 7, the storage 120 may generate a program completion signal based on an internal ready/busy signal Internal RB/, an external ready/busy signal External RB/ or a combination thereof, and transfer the generated program completion signal.

In an embodiment, the storage 120 may transfer the ready/busy signal RB/ to the controller 110, the ready/busy signal RB/ having a logic level which is determined according to whether a program and erase operation is being performed.

In an embodiment, the storage 120 may be configured to toggle the status of the internal ready/busy signal Internal RB/ at a point in time when unit data is completely programmed.

That is, the internal ready/busy signal Internal RB/ may retain a first logic level (low), while the unit data is programmed, and then toggle when the unit data is completely programmed (A). Therefore, the internal ready/busy signal Internal RB/ may toggle whenever (k−1)^{th} unit data, k^{th} unit data and (k+1)^{th} unit data are completely programmed.

In an embodiment, the storage 120 may output the external ready/busy signal External RB/ at a second logic level while unit data is programmed, and output a dummy signal CBSY whenever the unit data is completely programmed.

The controller 110 may recognize that the unit data is completely programmed, according to the internal ready/busy signal Internal RB/, the external ready/busy signal External RB/ or the combination thereof, and perform buffer release and assignment.

The method in which the storage 120 reports the program completion is not limited to the above-described example, but an applied and modified method among various methods which can be used to check the operation status of the storage 120 may be used.

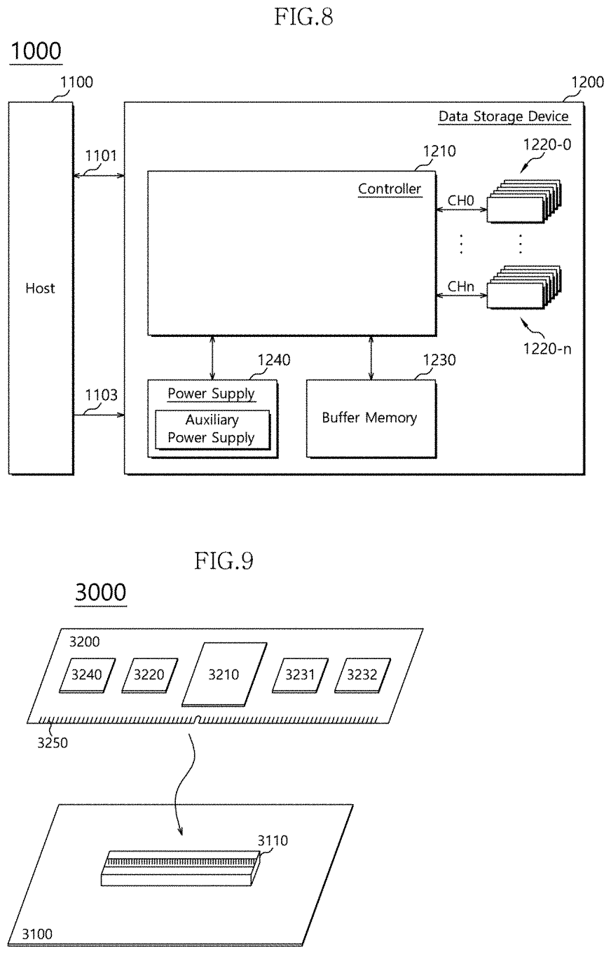

FIG. 8 is a diagram illustrating a data storage system in accordance with an embodiment.

Referring to FIG. 8, the data storage 1000 may include a host device 1100 and the data storage device 1200. In an embodiment, the data storage device 1200 may be configured as a solid state drive (SSD).

The data storage device 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the data storage device 1200. The controller 1210 may include a host interface unit, a control unit, a random access memory used as a working memory, an error correction code (ECC) unit, and a memory interface unit. In an embodiment, the controller 1210 may be configured similar to the controller 110 as shown is FIG. 1 to FIG. 2.

The host device 1100 may exchange a signal with the data storage device 1200 through the signal connector 1101. The signal may include a command, an address, data, and so forth.

The controller 1210 may analyze and process the signal received from the host device 1100. The controller 1210 may control operations of internal function blocks according to a firmware or a software for driving the data storage device 1200.

The buffer memory device 1230 may cache data to be stored in at least one of the nonvolatile memory devices 1220-0 to 1220-n. Further, the buffer memory device 1230 may cache the data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the data storage device 1200. The nonvolatile memory devices 1220-0 to 1220-n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power inputted through the power connector 1103, to the inside of the data storage device 1200. The power supply 1240 may include an auxiliary power supply. The auxiliary power supply may supply power to allow the data storage device 1200 to be normally terminated when a sudden power-off occurs. The auxiliary power supply may include large capacity capacitors.

The signal connector 1101 may be configured by various types of connectors depending on an interface scheme between the host device 1100 and the data storage device 1200.

The power connector 1103 may be configured by various types of connectors depending on a power supply scheme of the host device 1100.

FIG. 9 is a diagram illustrating a data processing system in accordance with an embodiment. Referring to FIG. 9, the data processing system 3000 may include a host device 3100 and the memory system 3200.

The host device 3100 may be configured in the form of a board such as a printed circuit board. Although not shown, the host device 3100 may include internal function blocks for performing the function of a host device.

The host device 3100 may include a connection terminal 3110 such as a socket, a slot or a connector. The memory system 3200 may be mounted to the connection terminal 3110.

The memory system 3200 may be configured in the form of a board such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control general operations of the memory system 3200. The controller 3210 may be configured in the same manner as the controller 110 shown in FIGS. 1 to 2.

The buffer memory device 3220 may temporarily store data to be stored in the nonvolatile memory devices 3231 and 3232. Further, the buffer memory device 3220 may cache the data read from the nonvolatile memory devices 3231 and 3232. The data temporarily cached in the buffer memory device 3220 may be transmitted to the host device 3100 or the nonvolatile memory devices 3231 and 3232 according to control of the controller 3210.

The nonvolatile memory devices 3231 and 3232 may be used as storage media of the memory system 3200.

The PMIC 3240 may provide the power inputted through the connection terminal 3250, to the inside of the memory system 3200. The PMIC 3240 may manage the power of the memory system 3200 according to control of the controller 3210.

The connection terminal 3250 may be coupled to the connection terminal 3110 of the host device 3100. Through the connection terminal 3250, signals such as commands, addresses, data and so forth, and power may be transferred between the host device 3100 and the memory system 3200. The connection terminal 3250 may be configured into various types depending on an interface scheme between the host device 3100 and the memory system 3200. The connection terminal 3250 may be disposed on any one side of the memory system 3200.

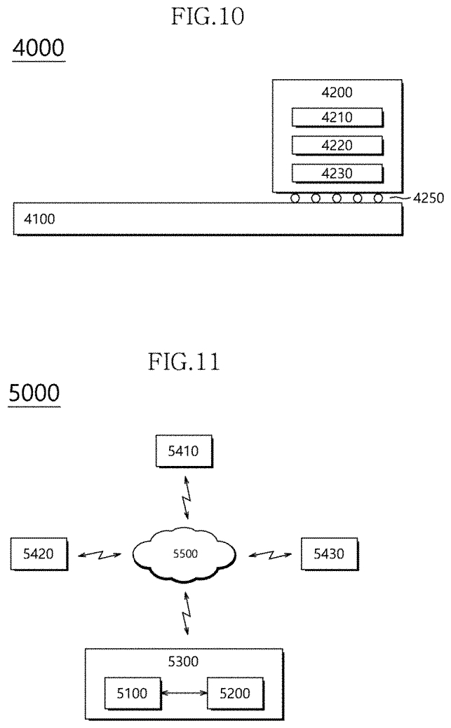

FIG. 10 is a diagram illustrating a data processing system in accordance with an embodiment. Referring to FIG. 10, the data processing system 4000 may include a host device 4100 and the memory system 4200.

The host device 4100 may be configured in the form of a board such as a printed circuit board. Although not shown, the host device 4100 may include internal function blocks for performing the function of a host device.

The memory system 4200 may be configured in the form of a surface-mounting type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 as shown in FIGS. 1 to 2.

The buffer memory device 4220 may cache data to be stored in the nonvolatile memory device 4230. Further, the buffer memory device 4220 may cache the data read from the nonvolatile memory device 4230. The data cached in the buffer memory device 4220 may be transmitted to the host device 4100 or the nonvolatile memory device 4230 according to control of the controller 4210.

The nonvolatile memory device 4230 may be used as the storage medium of the memory system 4200.

FIG. 11 is a diagram illustrating a network system including a data storage device in accordance with an embodiment. Referring to FIG. 11, the network system 5000 may include a server system 5300 and a plurality of client systems 5410 to 5430 which are coupled through a network 5500.

The server system 5300 may service data in response to requests from the plurality of client systems 5410 to 5430. For example, the server system 5300 may store the data provided from the plurality of client systems 5410 to 5430. For another example, the server system 5300 may provide data to the plurality of client systems 5410 to 5430.

The server system 5300 may include a host device 5100 and the memory system 5200. The memory system 5200 may be configured by the memory system 10 shown in FIG. 1, the data storage device 1200 shown in FIG. 8, the memory system 3200 shown in FIG. 9 or the memory system 4200 shown in FIG. 10.

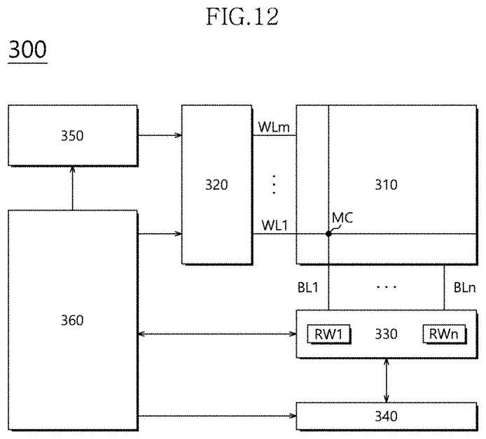

FIG. 12 is a block diagram illustrating a nonvolatile memory device included in a data storage device in accordance with an embodiment. Referring to FIG. 12, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The memory cell array 310 may comprise a three-dimensional memory array. The three-dimensional memory array has a direction perpendicular to the flat surface of a semiconductor substrate. Moreover, the three-dimensional memory array means a structure including NAND strings having at least one memory cell located in a vertical upper portion of the other memory cell.

The structure of the three-dimensional memory array is not limited thereto. It is apparent that the memory array structure can be selectively applied to a memory array structure formed in a highly integrated manner with horizontal directionality as well as vertical directionality.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control operations of the nonvolatile memory device 300 such as read, write and erase operations of the nonvolatile memory device 300.

While various embodiments have been described above, it will be understood to those skilled in the art that the embodiments described are examples only. Accordingly, the data storage device, the operating method thereof and the storage system including the same described herein should not be limited based on the described embodiments.

While various embodiments have been described above, it is will be understood to those skilled in the art that the embodiments described are examples only. Accordingly, the data storage device, the operation method and the memory system, which are described herein, should not be limited based on the described embodiments.

Although various embodiments have been described for illustrative purposes, it will be apparent to those skilled in the art that various changes and modifications may be made without departing from the spirit and scope of the invention as defined in the following claims.

What is claimed is:

1. A data storage device comprising:
a storage configured to generate a program completion signal when a data chunk is completely programmed;
a buffer memory having a plurality of buffer regions configured to cache a plurality of data chunks, respectively; and
a controller configured to:
receive a data chunk from a host device while a previously cached data chunk in the buffer memory is programmed to the storage;
cache the received data chunk into the buffer memory;
delete the programmed data chunk from the buffer memory in response to the program completion signal;
receive a new data chunk from the host device; and
cache the received new data chunk in an empty buffer region of the buffer memory.

2. The data storage device according to claim 1, wherein the controller is configured to cache the received new data chunk while the previously cached data chunk is programed.

3. The data storage device according to claim 1, wherein the storage comprises a plurality of dies, and the plurality of dies configured to simultaneously receive the data chunks from the buffer memory and program the received data chunks.

4. The data storage device according to claim 1, wherein the storage transfers the program completion signal in response to a status read command provided from the controller at a preset time point.

5. The data storage device according to claim 1, wherein the storage generates the program completion signal from an internal ready/busy signal, an external ready/busy signal or a combination of the internal ready/busy signal and the external ready/busy signal, and transfers the generated program completion signal.

6. A data storage device comprising:
a storage;
a buffer memory divided into a plurality of buffer regions; and
a controller configured to:
transfer a data chunk cached in the buffer memory to the storage;
cache a new data chunk into an empty buffer region of the buffer memory while the transferred data chunk is programmed;
release a buffer region in which the transferred data chunk is cached, in response to a program completion signal provided from the storage at a point in time when the transferred data chunk is completely programmed; and
assign the released buffer region as the empty buffer region.

7. An operation method of a data storage which includes a storage, a buffer memory and a controller configured to control data exchange with the storage, the operation method comprising the steps of:
caching, by the controller, a data chunk transferred from a host device into the buffer memory;
transferring, by the controller, the data chunk cached in the buffer memory to the storage to program the data chunk;
receiving, by the controller, a new data chunk from the host device and caching the new data chunk into the buffer memory, while the transferred data chunk is programmed;
generating, by the storage, a program completion signal when the transferred data chunk is completely programmed, and providing the generated program completion signal to the controller; and
deleting, by the controller, the programed data chunk from the buffer memory; and
assigning, by the controller, a buffer region, where the programmed data chunk is deleted, as an empty buffer region of the buffer memory.

8. The operation method according to claim 7, further comprising receiving, by the controller, another new data chunk from the host device, and caching the another new data chunk in the empty buffer region of the buffer memory, while a cached data chunk transferred to the storage is programmed.

9. The operation method according to claim 7, wherein the storage comprises a plurality of dies configured to program cached data chunks respectively and simultaneously provided from the buffer memory.

10. The operation method according to claim 7, wherein the step of transferring the program completion signal comprises the step of transferring, by the storage, the program completion signal in response to a status read command provided from the controller at a preset time point.

11. The operation method according to claim 7, wherein the step of transferring the program completion signal comprises the step of generating, by the storage, the program completion signal from an internal ready/busy signal, an external ready/busy signal or a combination of the internal ready/busy signal and the external ready/busy signal, and transferring the generated program completion signal.

12. A storage system comprising:
a host device; and
a data storage device comprising:
a storage configured to generate a program completion signal when a data chunk is completely programmed;
a buffer memory having a plurality of buffer regions configured to cache a plurality of data chunks, respectively; and
a controller configured to control data exchange with the storage,
wherein the controller:
receives a new data chunk from the host device while the data chunk cached in the buffer memory are programmed to the storage;
caches the received data chunk into the buffer memory;
deletes the programmed data chunk from the buffer memory in response to the program completion signal;
receives another new data chunk from the host device; and
caches the another new data chunk in an empty buffer region of the buffer memory.

13. The storage system according to claim 12, wherein the controller is configured to cache the another new data chunk while a cached data chunk in the buffer memory are programmed to the storage.

14. The storage system according to claim 12, wherein the storage comprises a plurality of dies configured to program cached data chunk respectively and simultaneously provided from the buffer memory.

15. The storage system according to claim 12, wherein the storage transfers the program completion signal in response to a status read command provided from the controller at a preset time point.

16. The storage system according to claim 12, wherein the storage generates the program completion signal from an internal ready/busy signal, an external ready/busy signal or a combination of the internal ready/busy signal and the external ready/busy signal, and transfers the generated program completion signal.

17. A memory system comprising:
a storage configured to generate a program completion signal when a data chunk is programmed;
a buffer memory having a plurality of buffer regions configured to cache a plurality of data chunks, respectively; and
a controller configured to:
receive a data chunk from a host device to cache the received data chunk into the buffer memory while a previously cached data chunk in the buffer memory is programmed to the storage;
delete the programmed data chunk cached in a buffer region of the buffer memory in response to the program completion signal; and
assign the buffer region, where the programmed data chunk is deleted, as an empty buffer region of the buffer memory.

18. The memory system according to claim 17, wherein the controller is configured to cache the received new data chunk in the empty buffer region of the buffer memory.
